(19) United States
(12) Patent Application Publication
(10) Pub. No.: US 2025/0308157 A1
(43) Pub. Date: Oct. 2, 2025

(54) INFORMATION PROCESSING APPARATUS, INFORMATION PROCESSING METHOD, AND COMPUTER READABLE MEDIUM

(71) Applicant: NEC Corporation, Tokyo (JP)

(72) Inventors: Yasuhiko YOSHIDA, Tokyo (JP); Rui KONDO, Tokyo (JP); Shinnosuke NISHIMOTO, Tokyo (JP); Kazuma KUNIYOSHI, Tokyo (JP)

(73) Assignee: NEC Corporation, Tokyo (JP)

(21) Appl. No.: 19/074,629

(22) Filed: Mar. 10, 2025

(30) Foreign Application Priority Data
Mar. 28, 2024 (JP) 2024-053500

(51) Int. Cl. G06T 17/00; G06F 3/01

(52) U.S. Cl. CPC G06T 17/00; G06F 3/013

(57) ABSTRACT

An information processing apparatus, an information processing method, and a computer readable medium capable of appropriately collecting attribute information of a user in a virtual space are provided. An information processing apparatus includes: an action information acquisition unit that acquires action information which is information regarding an action of an avatar viewing content in a virtual space; a determination unit that determines a degree of interest of a user corresponding to the avatar in the content on the basis of the action information; and a collection unit that collects attribute information and the degree of interest of the user as reaction information in a case where there is a consent of the user and collects the degree of interest as the reaction information in a case where there is no consent of the user.

### INCORPORATION BY REFERENCE

This application is based upon and claims the benefit of priority from Japanese patent application No. 2024-053500, filed on Mar. 28, 2024, the disclosure of which is incorporated herein in its entirety by reference.

### TECHNICAL FIELD

The present disclosure relates to an information processing apparatus, an information processing method, and a computer readable medium.

### BACKGROUND ART

For example, content including advertisements and the like is provided in virtual spaces which are called the metaverse and are constructed on the Internet by computers, for example. Users join the virtual space in a form called avatars, for example. The avatars perform actions that mimic the users' actions. Published Japanese Translation of PCT International Publication for Patent Application, No. 2010-535362 describes tracking an action of an avatar viewing a certain advertisement and providing information regarding the tracked action of the avatar to an advertiser. Furthermore, Published Japanese Translation of PCT International Publication for Patent Application, No. 2010-535362 describes performing data mining and profiling to determine predefined likes and dislikes, a geographical position, a language, and other attribute information of a user corresponding to the avatar.

### SUMMARY

However, Published Japanese Translation of PCT International Publication for Patent Application, No. 2010-535362 does not describe obtaining permission of the user for acquiring attribute information of the user. Protection of personal data and privacy has become strict in recent years like in the General Data Protection Regulation (GDPR) established in Europe in 2016. Therefore, it is difficult to acquire attribute information of a user without permission of the user.

An example object of the present disclosure is to provide an information processing apparatus, an information processing method, and a computer readable medium capable of appropriately collecting attribute information of a user in a virtual space.

An information processing apparatus according to a first example aspect of the present disclosure includes: an action information acquisition unit that acquires action information which is information regarding an action of an avatar viewing content in a virtual space; a determination unit that determines a degree of interest of a user corresponding to the avatar in the content on the basis of the action information; and a collection unit that collects attribute information and the degree of interest of the user as reaction information in a case where there is a consent of the user and collects the degree of interest as the reaction information in a case where there is no consent of the user.

An information processing system according to a second example aspect of the present disclosure includes: a virtual space operating system that provides a virtual space or an advertisement distribution system that distributes content including advertisements to the virtual space, in which the virtual space operating system or the advertisement distribution system includes an action information acquisition unit that acquires action information which is information regarding an action of an avatar viewing the content in the virtual space, a determination unit that determines a degree of interest of a user corresponding to the avatar in the content on the basis of the action information, and a collection unit that collects attribute information and the degree of interest of the user as reaction information in a case where there is a consent of the user and collects the degree of interest as the reaction information in a case where there is no consent of the user.

An information processing method according to a third example aspect of the present disclosure is a method that causes a computer to execute: action information acquisition processing of acquiring action information which is information regarding an action of an avatar viewing content in a virtual space; determination processing of determining a degree of interest of a user corresponding to the avatar in the content on the basis of the action information; and collection processing of collecting attribute information and the degree of interest of the user as reaction information in a case where there is a consent of the user and collecting the degree of interest as the reaction information in a case where there is no consent of the user.

A computer readable medium according to a fourth example aspect of the present disclosure stores a program that causes a computer to execute: action information acquisition processing of acquiring action information which is information regarding an action of an avatar viewing content in a virtual space; determination processing of determining a degree of interest of a user corresponding to the avatar in the content on the basis of the action information; and collection processing of collecting attribute information and the degree of interest of the user as reaction information in a case where there is a consent of the user and collecting the degree of interest as the reaction information in a case where there is no consent of the user.

According to the present disclosure, it is possible to provide an information processing apparatus, an information processing method, and a computer readable medium capable of appropriately collecting attribute information of a user in a virtual space.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a schematic block diagram illustrating an example of a configuration of an information processing apparatus according to the present disclosure;

FIG. 2 is a flowchart illustrating an example of an information processing method according to the present disclosure;

FIG. 3 is a schematic block diagram illustrating an example of a configuration of an information processing system according to the present disclosure;

FIG. 4 is a schematic block diagram illustrating another example of the configuration of the information processing system according to the present disclosure;

FIG. 5 is a flowchart illustrating an example of another information processing method according to the present disclosure; and

FIG. 6 is a block diagram illustrating an example of a configuration of a computer according to the present disclosure.

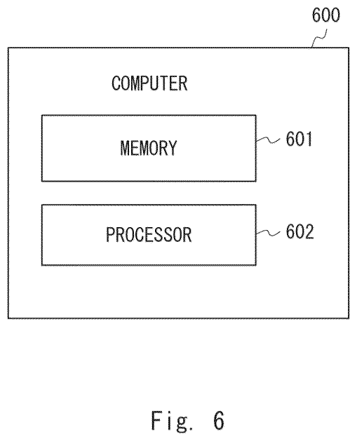

### EXAMPLE EMBODIMENT

### First Example Embodiment

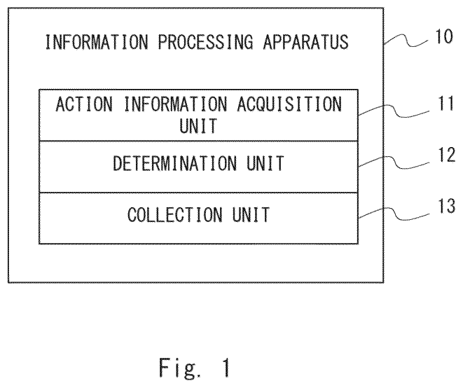

Hereinafter, an example of a configuration of an information processing apparatus 10 according to the present disclosure will be described with reference to FIG. 1. The information processing apparatus 10 appropriately collects attribute information of a user corresponding to an avatar which has entered a virtual space. Here, the virtual space is a virtual three-dimensional space constructed on a network such as the Internet by a computer. Specifically, the virtual space is generated by a computer and is expressed by three-dimensional computer graphics. Examples of the virtual space includes the metaverse. Also, the user joins the virtual space in a form called an avatar, for example. The avatar performs actions that mimic the actions of the user. The avatar is also generated by the computer and is expressed by three-dimensional computer graphics. Then, the information processing apparatus 10 determines a degree of interest of the user in the content from the actions of the avatar that has viewed the content including advertisements provided in the virtual space and collects attribute information of the user. Here, the attribute information includes an age, a gender, an occupation, a purchase history, an identity for advertisers (IDFA) of a user terminal used by the user, a preference, a taste, and the like of the user. Specifically, the information processing apparatus 10 includes an action information acquisition unit 11, a determination unit 12, and a collection unit 13 as illustrated in FIG. 1.

The action information acquisition unit 11 acquires action information that is information regarding actions of the avatar viewing the content in the virtual space. Here, the actions of the avatar include not only motions and activities of the avatar but also utterances of the avatar. Furthermore, the action information of the avatar may include content written in chat fields by the user corresponding to the avatar. Furthermore, the action information of the avatar may include facial expressions, movement of a line of sight, a heart rate, and brain waves of the user corresponding to the avatar.

The determination unit 12 determines the degree of interest of the user corresponding to the avatar in the content on the basis of the action information.

The collection unit 13 collects the attribute information and the degree of interest of the user as reaction information in a case where there is a consent of the user corresponding to the avatar, and collects the degree of interest as reaction information in a case where there is no consent of the user corresponding to the avatar. Here, the consent of the user is agreement of the user on the collection of the attribute information of the user. The consent of the user is acquired at least at any of a timing when application software for providing the virtual space is installed on a user terminal used by the user, a timing when the avatar corresponding to the user enters the virtual space, and a timing when the avatar is at a predetermined location in the virtual space.

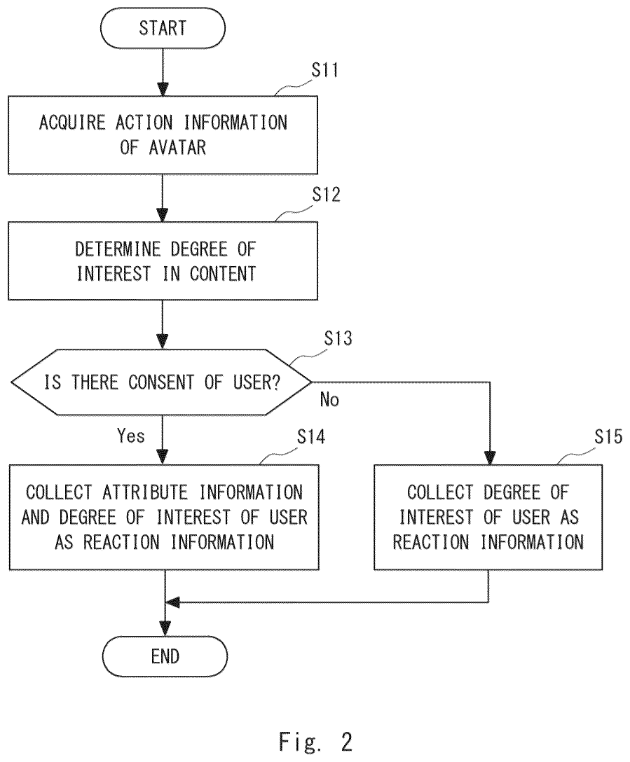

FIG. 2 is a flowchart illustrating an example of an information processing method according to the present disclosure. First, the action information acquisition unit 11 acquires action information of an avatar viewing content in a virtual space (Step S11). Next, the determination unit 12 determines a degree of interest of a user corresponding to the avatar in the content on the basis of the action information of the avatar acquired in Step S11 (step S12). Next, the collection unit 13 determines whether there is a consent of the user (step S13). In step S13, in a case where there is a consent of the user (step S13; Yes), the collection unit 13 collects the attribute information of the user and the degree-of-interest determined in step S11 as reaction information (step S14). In a case where there is no consent of the user in Step S13 (Step S13; No), the collection unit 13 collects the degree of interest determined in Step S11 as reaction information (Step S15) and ends the processing.

In the information processing apparatus 10 according to the present disclosure, the collection unit 13 collects attribute information and the degree of interest of the user as reaction information in a case where there is a consent of the user and collects the degree of interest of the user as the reaction information in a case where there is no consent of the user. In other words, the attribute information of the user is collected after the consent of the user is obtained. Therefore, it is possible to collect the attribute information of the user by obtaining the consent of the user even if protection of personal data and privacy is strict. Therefore, it is possible to provide the information processing apparatus 10 capable of appropriately collecting the attribute information of the user in the virtual space.

### Second Example Embodiment

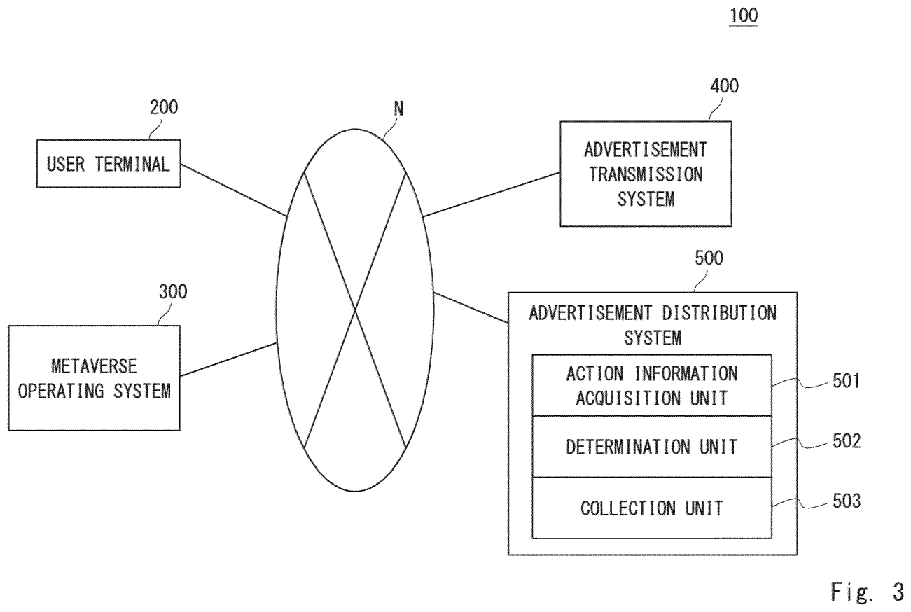

Hereinafter, an example of a configuration of an information processing system according to the present disclosure will be described with reference to FIG. 3. The following description will be given by exemplifying metaverse as the virtual space. An information processing system 100 illustrated in FIG. 3 includes a user terminal 200, a metaverse operating system 300, an advertisement transmission system 400, and an advertisement distribution system 500. The user terminal 200, the metaverse operating system 300, the advertisement transmission system 400, and the advertisement distribution system 500 can communicate with each other via a network N. Note that the number of user terminals 200 included in the information processing system 100 may be equal to or greater than the number of avatars joining the metaverse.

Each user terminal 200 is a smartphone, a personal computer (PC), virtual reality (VR) goggles, or the like used by the user. The user terminal 200 includes a camera that images actions of the user. Furthermore, the user terminal 200 may include various sensors that measure an eye line, a heart rate, brain waves, and the like of the user.

The metaverse operating system 300 constructs metaverse on the network N and operates the metaverse.

The advertisement transmission system 400 generates content including various advertisements that can be provided in the metaverse (hereinafter, simply referred to as “advertisement content”) and transmits (bids) the content to the advertisement distribution system 500.

The advertisement distribution system 500 provides appropriate advertisement content among various kinds of advertisement content transmitted (bid) from the advertisement transmission system 400 to the avatar in the metaverse. Specifically, the advertisement distribution system 500 includes an action information acquisition unit 501, a determination unit 502, and a collection unit 503 as illustrated in FIG. 3. Since functions of the action information acquisition unit 501, the determination unit 502, and the collection unit 503 are similar to those of the action information acquisition unit 11, the determination unit 12, and the collection unit 13, description thereof will be omitted. Also, the advertisement distribution system 500 collects reaction information of the user corresponding to the avatar viewing the content in the metaverse and determines advertisement content appropriate for the user on the basis of the reaction information of the user.

Similarly to the information processing apparatus 10 illustrated in FIG. 1, the information processing system 100 according to the present disclosure can appropriately collect attribute information of the user in the metaverse. Moreover, the advertisement distribution system 500 collects the reaction information of the user corresponding to the avatar viewing the content in the metaverse and determines advertisement content appropriate for the user on the basis of the reaction information of the user, in the information processing system 100 according to the present disclosure. Therefore, it is possible to optimize the advertisement content to be provided to the avatar in the metaverse.

### Third Example Embodiment

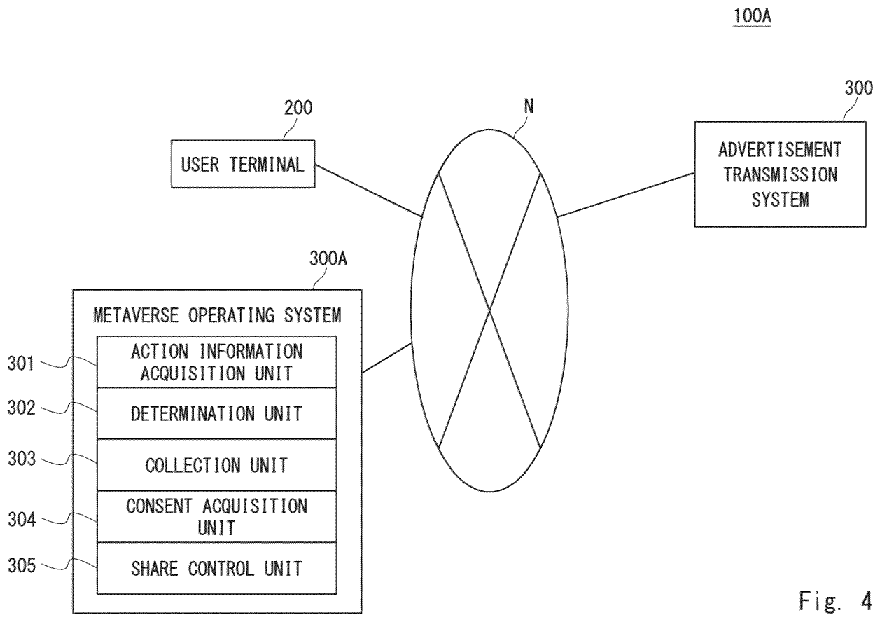

Next, another example of the configuration of the information processing system according to the present disclosure will be described with reference to FIG. 4. An information processing system 100A illustrated in FIG. 4 is different from the information processing system 100 illustrated in FIG. 3 in that the advertisement distribution system 500 is not included and a metaverse operating system 300A also functions as an advertisement distribution system. Furthermore, functions of a user terminal 200 and an advertisement transmission system 400 in the information processing system 100A illustrated in FIG. 4 are similar to those in the information processing system 100 illustrated in FIG. 3, and description thereof will thus be omitted.

The metaverse operating system 300A includes an action information acquisition unit 301, a determination unit 302, a collection unit 303, a consent acquisition unit 304, and a share control unit 305 as illustrated in FIG. 4. Also, the metaverse operating system 300A collects reaction information of a user corresponding to an avatar viewing content in the metaverse and determines advertisement content appropriate for the user on the basis of the reaction information of the user.

The action information acquisition unit 301 acquires action information that is information regarding actions of the avatar viewing the content in the metaverse. For example, the action information acquisition unit 301 may acquire motion of a field of view of the avatar as the action information. Here, the field of view of the avatar is a range from the center of the face of the avatar to predetermined angles on the left and right sides. For example, the action information acquisition unit 301 may acquire utterance of the avatar or content in a chat field as the action information. Also, the action information acquisition unit 301 may acquire a direction of the line of view of the avatar as the action information. Here, the direction of the line of sight of the avatar is a forward direction that the center of the face of the avatar faces. Furthermore, the action information of the avatar may include facial expressions, movement of a line of sight, a heart rate, and brain waves of the user corresponding to the avatar.

The determination unit 302 determines a degree of interest of the user corresponding to the avatar in the content on the basis of the action information. For example, the determination unit 302 may determine that the degree of interest is higher in a case where a proportion of a period of time during which the line of sight of the avatar is directed to certain content occupying a predetermined measurement period is equal to or greater than a predetermined threshold value than in a case where the proportion is less than the predetermined threshold value.

The collection unit 303 collects the attribute information and the degree of interest of the user as reaction information in a case where there is a consent of the user corresponding to the avatar, and collects the degree of interest as the reaction information in a case where there is no consent of the user corresponding to the avatar. For example, the collection unit 303 may acquire purchase history as the attribute information of the user from a non-fungible token (NFT) wallet associated with the metaverse operating system 300. Furthermore, the collection unit 303 may estimate a preference or a taste of the user as the attribute information of the user on the basis of the information acquired from the NFT wallet. Furthermore, the collection unit 303 may access a social networking service (SNS) described in a profile field of the avatar on the basis of the information of the SNS and acquire an age, a gender, and an occupation of the user corresponding to the avatar as the attribute information of the user on the basis of the information in the SNS. Furthermore, the collection unit 303 may estimate a preference or a taste of the user as the attribute information of the user on the basis of the information posted by the user on the SNS. Furthermore, the collection unit 303 may acquire an identity for advertisers of the user terminal 200 as the attribute information of the user. Moreover, the collection unit 303 may acquire information such as content browsed by the user in the past predetermined period as the attribute information of the user using the identity for advertisers of the user terminal 200. Also, the collection unit 303 may estimate a preference or a taste of the user as the attribute information of the user on the basis of the information such as content browsed by the user in the past predetermined period. Furthermore, the collection unit 303 may not collect reaction information in a case where the user corresponding to the avatar does not give even a consent to the collection of the degree of interest.

In addition, the collection unit 303 may collect the reaction information in a case where the degree of interest determined by the determination unit 302 is equal to or greater than a predetermined value. Specifically, the collection unit 303 may collect the attribute information and the degree of interest as the reaction information in a case where the degree of interest is equal to or greater than the predetermined value and there is a consent of the user. Also, the collection unit 303 may collect the degree of interest of the user as the reaction information in a case where the degree of interest is equal to or greater than the predetermined value and there is no consent of the user.

More specifically, the consent acquisition unit 304, which will be described later, provides message display to ask whether or not the user will agree with the collection of the attribute information of the user to the avatar in the metaverse in the case where the degree of interest is equal to or greater than the predetermined value. Then, the collection unit 303 collects the attribute information and the degree of interest of the user as the reaction information in a case where the avatar agrees with the message. Furthermore, the collection unit 303 collects the degree of interest of the user as the reaction information in a case where the avatar does not agree with the message.

The consent acquisition unit 304 acquires the consent of the user. Here, the consent of the user is agreement of the user on the collection of the attribute information of the user.

Specifically, the consent acquisition unit 304 may cause the user terminal 200 to display a message for asking whether or not the user will agree with the collection of the attribute information of the user and acquire the consent of the user at the time when application software for providing the metaverse is installed on the user terminal 200.

Furthermore, the consent acquisition unit 304 may acquire the consent of the user by causing the user terminal 200 to display a message for asking whether or not the user will agree with the collection of the attribute information of the user at the time when the avatar corresponding to the user enters the metaverse.

Furthermore, the consent acquisition unit 304 may acquire the consent of the user by providing message display to ask whether or not the user will agree with the collection of the attribute information of the user to the avatar at the time when the avatar is at a predetermined location in the metaverse. Here, the predetermined location in the metaverse is a space or the like for meeting that is provided at the time when the avatar moves from one metaverse space to another metaverse space inside the metaverse, for example, which is a space where advertisement content is provided.

Furthermore, the consent acquisition unit 304 may acquire the consent of the user by providing message display to ask whether or not the user will agree with the collection of the attribute information of the user to the avatar in a case where the degree of interest of the user in the content viewed by the avatar at the predetermined location in the metaverse is equal to or greater than a predetermined value.

The share control unit 305 encourages the user to agree to share with other users a fact that the user is interested in the content in a case where the degree of interest determined by the determination unit 302 is equal to or greater than a predetermined value. Specifically, the share control unit 305 provides a share button displaying “share on SNS”, for example, to the avatar corresponding to the user in the metaverse. Then, in a case where the avatar presses the share button, the share control unit 305 determines that the user has agreed to share with other users the fact that the user is interested in the content. Then, the share control unit 305 accesses the SNS described in the profile field of the avatar on the basis of the information of the SNS and posts a message such as “I am interested in this content”, for example, on the SNS. Furthermore, the share control unit 305 may cause the user terminal 200 to display a login screen of the SNS in a case where any information regarding an SNS is not described in the profile field of the avatar.

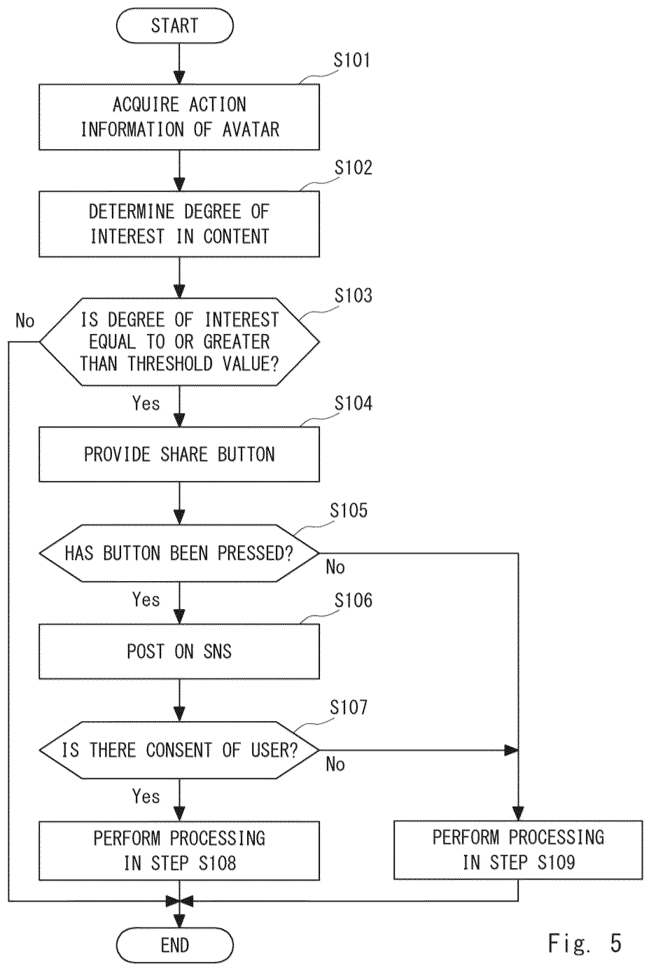

FIG. 5 is a flowchart illustrating an example of an information processing method according to the present disclosure. The processing in Steps S101, S102, S107, S108, and S109 in the flowchart illustrated in FIG. 5 is similar to the processing in Steps S11, S12, S13, S14, and S15 in the flowchart illustrated in FIG. 2, respectively, and description thereof will thus be omitted.

Next, the share control unit 305 determines whether the degree of interest determined in Step S102 is equal to or greater than a predetermined threshold value (Step S103).

In a case where the degree of interest determined in Step S102 is less than the predetermined threshold value in Step S103 (Step S103; No), the processing is ended.

In a case where it is determined that the degree of interest determined in Step S102 is equal to or greater than the predetermined threshold value in Step S103 (Step S103; Yes), the share control unit 305 provides a share button to the avatar in the metaverse (Step S104).

Next, the share control unit 305 determines whether the share button has been pressed by the avatar (Step S105).

In a case where the share button has not been pressed by the avatar in Step S105 (Step S105; No), the processing proceeds to Step S109.

In a case where the share button has been pressed by the avatar in Step S105 (Step S105; Yes), the share control unit 305 posts a message such as “I am interested in this content”, for example, on the SNS (Step S106), and the processing proceeds to Step S107.

Similarly to the information processing system 100 illustrated in FIG. 3, the information processing system 100A according to the present disclosure can appropriately collect the attribute information of the user in the metaverse. Moreover, the metaverse operating system 300A collects reaction information of the user corresponding to the avatar viewing the content in the metaverse and determines advertisement content appropriate for the user on the basis of the reaction information of the user, in the information processing system 100A according to the present disclosure. Therefore, it is possible to optimize the advertisement content to be provided to the avatar in the metaverse.

Also, the consent acquisition unit 304 may acquire a consent of the user at any of a timing when application software for providing the metaverse is installed on the user terminal 200, a timing when the avatar enters the metaverse, and a timing when the avatar is at a predetermined location in the metaverse. Therefore, the user can agree with the collection of the attribute information of the user at any of the timings.

Also, the action information acquisition unit 301 acquires a motion of a field of view of the avatar, utterance of the avatar, content in a chat field, or the like as action information. Therefore, it is possible to appropriately determine the degree of interest of the user corresponding to the avatar in the content from the action of the avatar.

Furthermore, the determination unit 302 determines the degree of interest of the user corresponding to the avatar in the content on the basis of a proportion of a period of time during which a line of sight of the avatar is directed to certain content occupying a predetermined measurement time. Therefore, it is possible to appropriately determine the degree of interest of the user in the content.

In addition, the collection unit 303 collect reaction information in a case where the degree of interest determined by the determination unit 302 is equal to or greater than a predetermined value. In a case where the degree of interest of the user in the content is high, it is expected that there is a high probability that the user will agree with the collection of the attribute information of the user. Therefore, the consent acquisition unit 304 provides message display to ask whether or not the user will agree with the collection of the attribute information of the user to the avatar in the metaverse in the case where the degree of interest is equal to or greater than the predetermined value. Then, the collection unit 303 collects the attribute information and the degree of interest of the user as the reaction information in a case where the avatar agrees with the message. Furthermore, the collection unit 303 collects the degree of interest of the user as the reaction information in a case where the avatar does not agree with the message. In this manner, the collection unit 303 can collect the attribute information of the user in a case where the consent of the user is more easily obtained.

Although the present disclosure has been described as hardware configurations in the above example embodiments, the present disclosure is not limited thereto. The aforementioned functions (processing) of the information processing apparatus 10, the user terminal 200, the metaverse operating systems 300 and 300A, the advertisement transmission system 400, and the advertisement distribution system 500 may be realized by, for example, a computer 600 having the following configuration.

FIG. 13 is a block diagram illustrating a configuration of a computer 600 that realizes the processing of the information processing apparatus 10, the user terminal 200, the metaverse operating systems 300 and 300A, the advertisement transmission system 400, and the advertisement distribution system 500. As illustrated in FIG. 13, the computer 600 includes a memory 601 and a processor 602.

The memory 601 is configured of, for example, a combination of a volatile memory and a nonvolatile memory. The memory 601 is used to store a program executed by the processor 602 and data and the like used for various kinds of processing. Storage units (not illustrated) of the information processing apparatus 10, the user terminal 200, the metaverse operating systems 300 and 300A, the advertisement transmission system 400, and the advertisement distribution system 500 may be realized by the memory 601. However, these may be realized by another arbitrary storage device.

The processor 602 performs the processing of the devices by reading and executing the program in the memory 601. The processor 602 may be, for example, a microprocessor, a micro processor unit (MPU), or a central processing unit (CPU). The processor 602 may include a plurality of processors.

In the above examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Although some or all of the above-described example embodiments may be described as in the following Supplementary Notes, the present disclosure is not limited to the following Supplementary Notes.

### (Supplementary Note 1)

An information processing apparatus including:
an action information acquisition unit that acquires action information which is information regarding an action of an avatar viewing content in a virtual space;
a determination unit that determines a degree of interest of a user corresponding to the avatar in the content on the basis of the action information; and
a collection unit that collects attribute information and the degree of interest of the user as reaction information in a case where there is a consent of the user and collects the degree of interest as the reaction information in a case where there is no consent of the user.

### (Supplementary Note 2)

The information processing apparatus according to Supplementary Note 1, further including a consent acquisition unit that acquires the consent of the user at least at any of a timing when application software for providing the virtual space is installed on a user terminal of the user, a timing when the avatar enters the virtual space, and a timing when the avatar is at a predetermined location in the virtual space.

### (Supplementary Note 3)

The information processing apparatus according to Supplementary Note 1, in which the action information acquisition unit acquires a motion of a field of view of the avatar as the action information.

### (Supplementary Note 4)

The information processing apparatus according to Supplementary Note 1, in which the action information acquisition unit acquires an utterance of the avatar or content in a chat field as the action information.

### (Supplementary Note 5)

The information processing apparatus according to Supplementary Note 1, in which the determination unit determines that the degree of interest is higher in a case where a proportion of a period of time during which a line of sight of the avatar is directed to the content occupying a predetermined measurement time is equal to or greater than a predetermined threshold value than in a case where the proportion is less than the predetermined threshold value.

### (Supplementary Note 6)

The information processing apparatus according to Supplementary Note 1, in which the collection unit collects the reaction information in a case where the degree of interest is equal to or greater than a predetermined value.

### (Supplementary Note 7)

The information processing apparatus according to Supplementary Note 1, further including a share control unit that encourages the user to agree to share with other users a fact that the user is interested in the content in a case where the degree of interest is equal to or greater than a predetermined value.

### (Supplementary Note 8)

An information processing system including a virtual space operating system that provides a virtual space or an advertisement distribution system that distributes content including advertisements to the virtual space, wherein the virtual space operating system or the advertisement distribution system includes
an action information acquisition unit that acquires action information which is information regarding an action of an avatar viewing the content in the virtual space,
a determination unit that determines a degree of interest of a user corresponding to the avatar in the content on the basis of the action information, and
a collection unit that collects attribute information and the degree of interest of the user as reaction information in a case where there is a consent of the user and collects the degree of interest as the reaction information in a case where there is no consent of the user.

### (Supplementary Note 9)

The information processing system according to Supplementary Note 8, in which the virtual space operating system or the advertisement distribution system further includes a consent acquisition unit that acquires the consent of the user at least at any of a timing when application software for providing the virtual space is installed on a user terminal of the user, a timing when the avatar enters the virtual space, and a timing when the avatar is at a predetermined location in the virtual space.

### (Supplementary Note 10)

The information processing system according to Supplementary Note 8, in which the action information acquisition unit acquires a motion of a field of view of the avatar as the action information.

### (Supplementary Note 11)

The information processing system according to Supplementary Note 8, in which the action information acquisition unit acquires an utterance of the avatar or content in a chat field as the action information.

### (Supplementary Note 12)

The information processing system according to Supplementary Note 8, in which the determination unit determines that the degree of interest is higher in a case where a proportion of a period of time during which a line of sight of the avatar is directed to the content occupying a predetermined measurement time is equal to or greater than a predetermined threshold value than in a case where the proportion is less than the predetermined threshold value.

### (Supplementary Note 13)

The information processing system according to Supplementary Note 8, in which the collection unit collects the reaction information in a case where the degree of interest is equal to or greater than a predetermined value.

### (Supplementary Note 14)

The information processing system according to Supplementary Note 8, in which the virtual space operating system or the advertisement distribution system further includes a share control unit that encourages the user to agree to share with other users a fact that the user is interested in the content in a case where the degree of interest is equal to or greater than a predetermined value.

### (Supplementary Note 15)

An information processing method that causes a computer to execute:
action information acquisition processing of acquiring action information which is information regarding an action of an avatar viewing content in a virtual space;
determination processing of determining a degree of interest of a user corresponding to the avatar in the content on the basis of the action information; and
collection processing of collecting attribute information and the degree of interest of the user as reaction information in a case where there is a consent of the user and collecting the degree of interest as the reaction information in a case where there is no consent of the user.

### (Supplementary Note 16)

The information processing method according to Supplementary Note 15, in which the computer executes consent acquisition processing of acquiring the consent of the user at least at any of a timing when application software for providing the virtual space is installed on a user terminal of the user, a timing when the avatar enters the virtual space, and a timing when the avatar is at a predetermined location in the virtual space.

### (Supplementary Note 17)

The information processing method according to Supplementary Note 15, in which the computer acquires a motion of a field of view of the avatar as the action information in the action information acquisition processing.

### (Supplementary Note 18)

The information processing method according to Supplementary Note 15, in which the computer acquires an utterance of the avatar or content in a chat field as the action information in the action information acquisition processing.

### (Supplementary Note 19)

The information processing method according to Supplementary Note 15, in which the computer determines that the degree of interest is higher in a case where a proportion of a period of time during which a line of view of the avatar is directed to the content occupying a predetermined measurement period is equal to or greater than a predetermined threshold value than in a case where the proportion is less than the predetermined threshold value, in the determination processing.

### (Supplementary Note 20)

The information processing method according to Supplementary Note 15, in which the computer collects the reaction information in a case where the degree of interest is equal to or greater than a predetermined value, in the collection processing.

### (Supplementary Note 21)

The information processing method according to Supplementary Note 15, in which the computer executes share control processing of encouraging the user to agree to share with other users a fact that the user is interested in the content in a case where the degree of interest is equal to or greater than a predetermined value.

### (Supplementary Note 22)

A program that causes a computer to execute:
action information acquisition processing of acquiring action information which is information regarding an action of an avatar viewing content in a virtual space;
determination processing of determining a degree of interest of a user corresponding to the avatar in the content on the basis of the action information; and
collection processing of collecting attribute information and the degree of interest of the user as reaction information in a case where there is a consent of the user and collecting the degree of interest as the reaction information in a case where there is no consent of the user.

### (Supplementary Note 23)

The program according to Supplementary Note 22, in which the computer is caused to execute consent acquisition processing of acquiring the consent of the user at least at any of a timing when application software for providing the virtual space is installed on a user terminal of the user, a timing when the avatar enters the virtual space, and a timing when the avatar is at a predetermined location in the virtual space.

### (Supplementary Note 24)

The program according to Supplementary Note 22, in which the computer is caused to acquire a motion of a field of view of the avatar as the action information in the action information acquisition processing.

### (Supplementary Note 25)

The program according to Supplementary Note 22, in which the computer is caused to acquire an utterance of the avatar or content in a chat field as the action information in the action information acquisition processing.

### (Supplementary Note 26)

The program according to Supplementary Note 22, in which the computer is caused to determine that the degree of interest is higher in a case where a proportion of a period of time during which a line of view of the avatar is directed to the content occupying a predetermined measurement period is equal to or greater than a predetermined threshold value than in a case where the proportion is less than the predetermined threshold value, in the determination processing.

### (Supplementary Note 27)

The program according to Supplementary Note 22, in which the computer is caused to collect the reaction information in a case where the degree of interest is equal to or greater than a predetermined value, in the collection processing.

### (Supplementary Note 28)

The program according to Supplementary Note 22, in which the computer is caused to execute share control processing of encouraging the user to agree to share with other users a fact that the user is interested in the content in a case where the degree of interest is equal to or greater than a predetermined value.

What is claimed is:

1. An information processing apparatus comprising:
a memory storing instructions; and
one or more processors configured to execute the instructions to:
acquire action information which is information regarding an action of an avatar viewing content in a virtual space;
determine a degree of interest of a user corresponding to the avatar in the content on the basis of the action information; and
collect attribute information and the degree of interest of the user as reaction information in a case where there is a consent of the user and collects the degree of interest as the reaction information in a case where there is no consent of the user.

2. The information processing apparatus according to claim 1, the one or more processors configured to execute the instructions to: acquire the consent of the user at least at any of a timing when application software for providing the virtual space is installed on a user terminal of the user, a timing when the avatar enters the virtual space, and a timing when the avatar is at a predetermined location in the virtual space.

3. The information processing apparatus according to claim 1, wherein the action information acquisition unit acquires a motion of a field of view of the avatar as the action information.

4. The information processing apparatus according to claim 1, wherein the one or more processors acquires an utterance of the avatar or content in a chat field as the action information.

5. The information processing apparatus according to claim 1, wherein the one or more processors determines that the degree of interest is higher in a case where a proportion of a period of time during which a line of sight of the avatar is directed to the content occupying a predetermined measurement time is equal to or greater than a predetermined threshold value than in a case where the proportion is less than the predetermined threshold value.

6. The information processing apparatus according to claim 1, wherein the one or more processors collects the reaction information in a case where the degree of interest is equal to or greater than a predetermined value.

7. The information processing apparatus according to claim 1, the one or more processors configured to execute the instructions to: encourage the user to agree to share with other users a fact that the user is interested in the content in a case where the degree of interest is equal to or greater than a predetermined value.

8. An information processing method that causes a computer to execute:
action information acquisition processing of acquiring action information which is information regarding an action of an avatar viewing content in a virtual space;
determination processing of determining a degree of interest of a user corresponding to the avatar in the content on the basis of the action information; and
collection processing of collecting attribute information and the degree of interest of the user as reaction information in a case where there is a consent of the user and collecting the degree of interest as the reaction information in a case where there is no consent of the user.

9. A computer readable medium storing a program that causes a computer to execute:
action information acquisition processing of acquiring action information which is information regarding an action of an avatar viewing content in a virtual space;
determination processing of determining a degree of interest of a user corresponding to the avatar in the content on the basis of the action information; and
collection processing of collecting attribute information and the degree of interest of the user as reaction information in a case where there is a consent of the user and collecting the degree of interest as the reaction information in a case where there is no consent of the user.
